(19) United States
(12) Patent Application Publication
(10) Pub. No.: US 2024/0320029 A1
(43) Pub. Date: Sep. 26, 2024

(54) MANAGING DATA PLACEMENT FOR DIRECT ASSIGNED VIRTUAL MACHINES IN A MEMORY SUB-SYSTEM

(71) Applicant: MICRON TECHNOLOGY, INC., Boise, ID (US)

(72) Inventor: Luca Bert, San Jose, CA (US)

(21) Appl. No.: 18/590,807

(22) Filed: Feb. 28, 2024

Related U.S. Application Data
(60) Provisional application No. 63/453,667, filed on Mar. 21, 2023.

(51) Int. Cl. G06F 9/455

(52) U.S. Cl. CPC G06F 9/45558; G06F 2009/45583

(57) ABSTRACT

A memory system includes a memory device and a processing device coupled to the memory device, the processing device is to create a namespace by allocating a reclaim group, the reclaim group comprising a plurality of reclaim units; assign a reclaim unit handle to the namespace; receive, from a virtual machine running on a host computing system, a command to perform an operation associated with the namespace; identify a segment of the memory device based on the reclaim unit handle that is assigned to the namespace; and perform the operation on the segment of the memory device.

### RELATED APPLICATIONS

This application claims the benefit of U.S. Provisional Patent Application No. 63/453,667, filed Mar. 21, 2023, the entire contents of which are incorporated by reference herein.

### TECHNICAL FIELD

Embodiments of the disclosure relate generally to memory sub-systems, and more specifically, relate to managing data placement for direct assigned virtual machines in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system in accordance with some embodiments of the present disclosure.

FIG. 2 illustrates an example virtualization internal management component included in a memory sub-system in accordance with some embodiments of the present disclosure.

FIG. 3 illustrates another virtualization internal management component included in a memory sub-system in accordance with some embodiments of the present disclosure.

FIG. 4 illustrates a physical controller implementing a virtualization internal management component in accordance with some embodiments of the present disclosure.

FIGS. 5-6 are flow diagrams of example methods to manage data placement in a memory sub-system in accordance with some embodiments of the present disclosure.

FIG. 7 is a block diagram of an example computer system in which embodiments of the present disclosure can operate.

### DETAILED DESCRIPTION

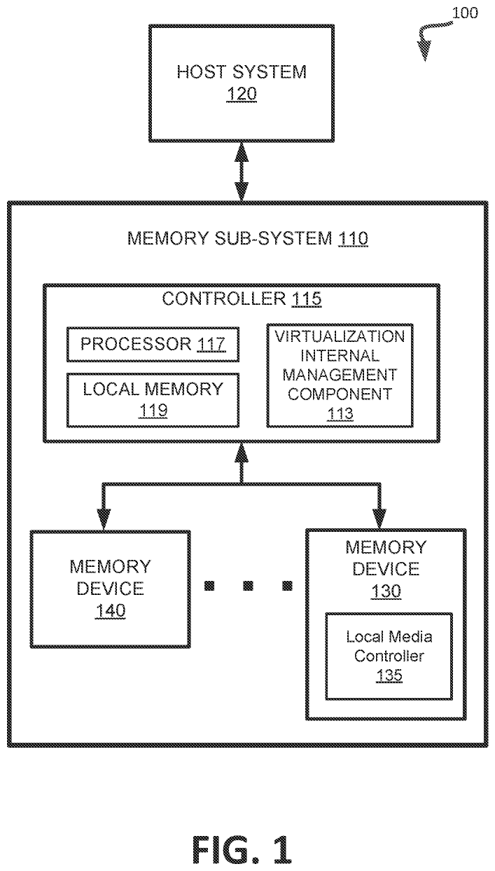

Aspects of the present disclosure are directed to managing data placement for direct assigned virtual machines in a memory sub-system. A memory sub-system can be a storage device, a memory module, or a combination of a storage device and memory module. Examples of storage devices and memory modules are described below in conjunction with FIG. 1. An example of a memory sub-system is a storage device that is coupled to a central processing unit (CPU) via a peripheral interconnect (e.g., an input/output bus, a storage area network). Examples of storage devices include a solid-state drive (SSD), a flash drive, a universal serial bus (USB) flash drive, and a hard disk drive (HDD). Another example of a memory sub-system is a memory module that is coupled to the CPU via a memory bus. Examples of memory modules include a dual in-line memory module (DIMM), a small outline DIMM (SO-DIMM), a non-volatile dual in-line memory module (NVDIMM), etc. In some embodiments, the memory sub-system can be a hybrid memory/storage sub-system. In general, a host system can utilize a memory sub-system that includes one or more memory components. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is a NAND memory device, such as 3D flash NAND memory, which offers storage in the form of compact, high density configurations. Other examples of non-volatile memory devices are described below in conjunction with FIG. 1. A non-volatile memory device is a package of one or more die. Each die can include one or more planes. For some types of non-volatile memory devices (e.g., NAND memory devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

Memory access commands, such as those sent by the host system, request the memory sub-system to perform memory access operations on the memory devices of the memory sub-system. Memory access commands can generally be classified into respective categories, such as read commands, write commands, erase commands, move commands, etc. A memory sub-system controller can receive the memory access commands from the host system connected externally to the memory sub-system, such as via a Non-Volatile Memory Express (NVMe) interface on a Peripheral Component Interconnect Express (PCIe) communication bus. The memory sub-system can execute the memory access commands to perform the memory access operations and return the results of executing the memory access commands to the host system via the host interface.

The memory sub-system can present one or more physical functions to the host system over the PCIe interface. A physical function may represent a partitioned part of a memory sub-system that is associated with a given host system. A memory sub-system can be partitioned into multiple portions using multiple physical functions. In some systems, the memory sub-systems utilize a specification that allows the isolation of PCIe resources among various hardware functions for manageability and performance reasons, while also allowing single physical PCIe devices to be shared in a virtual environment. A physical function allows enumeration of a number of virtual functions and the host system, via a hypervisor, can then assign those virtual functions to one or more virtual machines running on the host system. Such virtual environment thus can provide abstractions of the physical components into logical objects in order to allow running various software modules, such as for example, multiple operating systems, concurrently and in isolation from other software modules, on one or more interconnected physical computer systems. Still, in the virtual environment, some media management is in need to render a better performance of the memory sub-system.

For example, a memory sub-system controller can perform media management operations, such as wear leveling, refresh, garbage collection, scrub, etc., on a block that includes one or more pages containing valid data while the remaining pages can contain invalid data. To avoid waiting for a threshold number of pages in the block to have invalid data in order to erase and reuse the block, the memory sub-system controller can perform garbage collection operations to allow the block to be erased and released as a free block for subsequent write operations. Garbage collection is a process to recover free space by relocating pages with data to new blocks, and erasing old blocks. Specifically, a block can include valid data pages and data pages that are no longer needed (e.g., stale pages). Garbage collection generally involves copying only the valid data pages from a source block to a destination block and then erasing the source block to free the space. As a result, the number of blocks that have been erased can be increased such that more blocks are available to store subsequent data from a host system. This additional re-write of valid data in the data blocks during a garbage collection operation results in write amplification. Write amplification manifests itself by the amount of physical data to be written to the storage media being a multiple of the logical amount of data manipulated by the host. Write amplification can reduce the operating life and impact performance of the memory sub-system.

In the virtual environment, garbage collection and write amplification can occur similarly, leading to that the data placement associated with a virtual machine can be scattered among multiple blocks, and data from different virtual machine can be mixed together. Such data placement scattering would adversely affect the performance of the memory device, and quality of service (QOS) (e.g., bandwidth or other characteristics) associated with virtual machine, for example, due to the interference of a block used by one virtual machine with an adjacent block used by another virtual machine.

Flexible Data Placement (FDP) is a set of the NVM commands as defined by the NVMe™) Specification. FDP can be used to reduce the garbage collection and write amplification. Specifically, FDP enables host-guided data placement to allow data referenced by a specific placement identifier which in turn points to a reclaim unit (RU). RUs are units of a physical, non-volatile storage that can be programmed, read, erased, reused, or repurposed without disturbing each other. The specific placement identifier pointing to a RU can include a reclaim unit handle (RUH). The host system can tag a write command with the RUH to identify the RU where the data specified in the write command should be written. The host system requires to be aware of RUH to perform such operation. However, in the virtual environment, the host system cannot ask the virtual machines to be aware of RUH, and thus, cannot use FDP in the existing manner.

Aspects of the present disclosure address the above and other deficiencies by implementing a memory sub-system that allows isolation of direct-assigned virtual machines from each other by having a memory space used by one direct-assigned virtual machine physically isolated from another memory space used by another direct-assigned virtual machine. Specifically, a memory sub-system controller can create multiple namespaces by allocating a set of superblocks (e.g., a reclaim group) to each namespace and assign a respective handle (e.g., reclaim unit handle) to each namespace. The handle (e.g., reclaim unit handle) is used to identify the superblock (e.g., a reclaim unit) that is active (e.g., last-written) in the set of superblocks. Therefore, as the superblocks are physically isolated portions of the memory device, the namespace mapped to the superblock would provide the virtual machine physically isolated data placement. When the memory sub-system controller receives, from a virtual machine, a command to perform a write operation associated with a namespace, the memory sub-system controller can identify a segment of the memory device based on the handle assigned to the namespace, and perform the operation on the segment of the memory device. Because the handle is used internally by the memory sub-system controller, the virtual machine running on the host system would not be aware of the existence of the handle, but is still provided with physically isolated memory space. The concepts regarding “namespace,” “reclaim group,” “reclaim unit handle,” and the direct-assigned virtual machine will be described below.

When the host system requests to access data (e.g., read data, write data), the host system can send a memory access command to the memory sub-system directed to a logical address space. The logical address space can include an identifiable logical unit, such as a logical block (e.g., the smallest write/read unit). In certain memory sub-systems, the host system can provide logical address information (e.g., logical block address (LBA)) identifying the location where the data is to be stored at or read from. The logical address information (e.g., LBA) can be part of metadata for the host data. In certain memory devices, the logical address space of the memory device is divided into namespaces that allow for more efficient management of data. Each namespace can be mapped to multiple logical blocks. For example, one or more LBAs can be mapped to a particular namespace. Each namespace can be referenced using a namespace identifier. Each namespace can include a namespace data structure (e.g., a table) that is created, updated, or deleted, e.g., using NameSpace Management and Namespace Attachment commands as defined by the NVM Express™ (NVMe™) Specification. The namespace data structure can indicate capabilities and settings that are specific to a particular namespace.

In some implementations, one or more RUs can form a reclaim group (RG), where an RG corresponds to a namespace. As such, an RG can be an addressable data storage unit that includes a predefined number of smaller addressable data storage units of an order that is lower than the RG, and thus the RG can refer to a higher-order data storage unit, while the RU can refer to a lower-order data storage unit. In some examples, a RU can have a granularity of a predefined number of blocks and can be a superblock, and an RG can be a set of superblocks that includes a predefined number of the RU. For example, a RU can be one superblock, and an RG can be a set of superblocks that includes one usable superblock from each plane on a set of dies of a memory device. Each superblock can be located on a separate plane having independent circuitry allowing parallel operations to be performed on the set of superblocks. In a preferred embodiment, the RG would be physically isolated to each other to minimize the interference of performance to each other. For example, a first RG is allocated in a first set of dies, e.g., die 1 to die 8, and a second RG is allocated in a second set of dies, e.g., die 9 to die 16, where the first set of dies and the second set of dies are physically isolated to each other.

In some implementations, the memory sub-system controller can receive and process a request to create a namespace. Accordingly, the memory sub-system controller can create a namespace by allocating an RG to the namespace. Specifically, the memory sub-system controller can allocate the RG by selecting a set of RUs, where the number of RUs in the set of RUs is predetermined (e.g., with a default value) or determined at the time of creating a virtual machine. In some implementations, the size of a namespace and the size of a RU are predefined, and the memory sub-system controller can determine the number of the RUs to be a sum of the integer part (I) of the quotient of the size of the namespace divided by the size of the RU and an extra number (E), where the extra number allows the memory sub-system working efficiently, for example, used for over-provisioning. For example, assuming that the size of a namespace is 128 GB and the size of a RU is 10 GB, the integer part (I) would be 12, and the extra number (E) can be 1, leading to the number of the RUs to be 13; in such a case, the memory sub-system controller can create a namespace by allocating a RG with 13 RUs to the namespace.

After the memory sub-system controller creates one or more namespaces, the memory sub-system controller can assign one RUH to each namespace. The RUH is unique to the specific namespace, and the specific namespace can only have one RUH. Although RUH is used here, other forms of handles, tags, etc. can be used to replace RUH to reference to the namespace. In some implementations, the memory sub-system controller can store the assignment between the RUH and the namespace identifier in a data structure.

With respect to direct-assigned virtual machine, the memory sub-system controller can present two or more physical or virtual functions (PFs/VFs) or assignable device interface (ADI) to the host system 120 over an interconnect, such as a PCIe interface. The host system 120 can assign each of the PFs/VFs/ADIs to virtual machines and assign one or more namespaces to one or more of the PFs/VFs/ADIs. When a virtual machine send, to the memory sub-system controller, a request to perform a memory access operation associated with a namespace, the memory sub-system controller can use the namespace identifier included in the request to identify the RUH, where the RUH can be further used to identify the RG. The memory sub-system controller performs the requested memory access operation on the identified RG.

Advantages of the present disclosure include improved performance by reducing write amplification and improved quality of service control specific to lower interference between adjacent blocks by the reclaim group isolation. Thus, aspects of the present disclosure give a more granular control over the data placement for virtual machines and further improve performance and quality of service of the virtual machines. For example, with existing technology, deleting a virtual machine involves removing all its data, which creates holes in the data maps that are hard to manage and creates high write amplification due to the garbage collection. According to the present disclosure, instead, deleting a virtual machine will only involve deletion of data in all RUs in an RG, which is an isolated operation that occurs on physically dedicated blocks and, in theory, results in zero write amplification.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processors.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

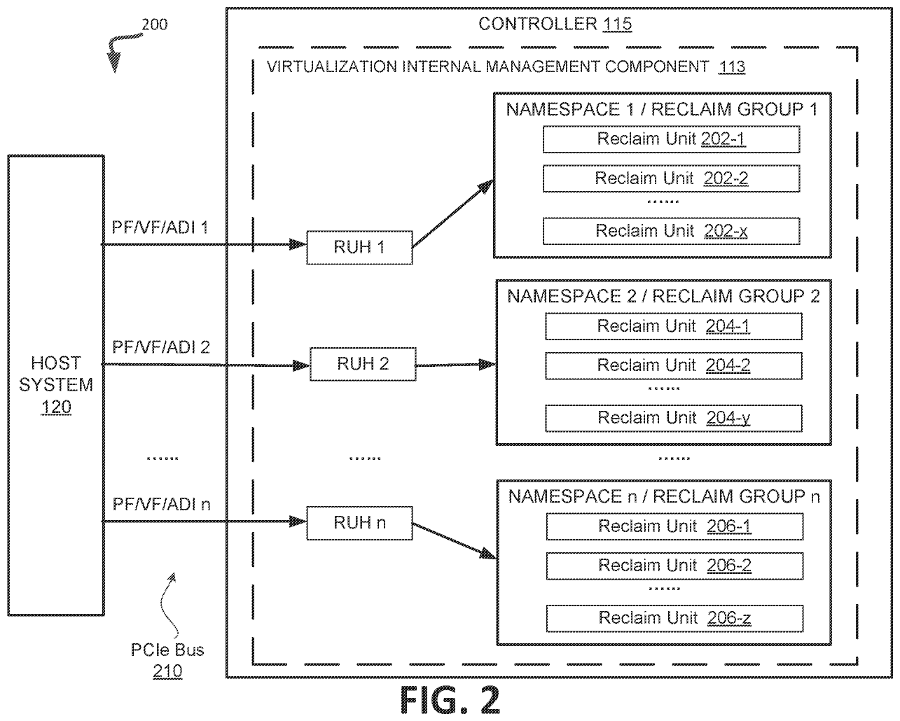

The memory sub-system 110 includes a virtualization internal management component 113 that is capable of managing the data placement of direct assigned virtual machine by internally using components of FDP In some embodiments, the controller 115 includes at least a portion of the virtualization internal management component 113. For example, the controller 115 can include a processor 117 (processing device) configured to execute instructions stored in local memory 119 for performing the operations described herein. In some embodiments, some of the functionality of the virtualization internal management component 113 can be implemented as part of the processor 117, as part of firmware on the controller 115, as part of an application or an operating system executing on the processor 117. Alternatively, some of the functionality of the virtualization internal management component 113 can be implemented as part of the host system 120. Details of the virtualization internal management component 113 are described with respect to FIGS. 2-7.

FIG. 2 illustrates a virtualization internal management component in a memory sub-system in accordance with some embodiments of the present disclosure. The system 200 can include the host system 120, one or more memory devices (not shown), and a controller 115 that is operatively coupled with the memory devices. In one embodiment, the controller 115 of memory sub-system 110 is connected to host system 120 over a physical host interface, such as PCIe bus 210. In one embodiment, the controller 115 can provide a direct assignment of the virtual machine. The controller 115 can expose the different portions of the memory devices to the virtual machines through various techniques, including single root input/output virtualization (SrIOV), multiple physical functions (MPF), and scalable I/O virtualization (sIOV or scalable IOV), which will be described below in detail. Using these techniques, the controller 115 can present two or more physical or virtual functions (PFs/VFs) or assignable device interfaces (ADIs) to the host system 120 over an interconnect, such as a PCIe interface. The host system 120 can assign each of the PFs/VFs/ADIs to individual applications, virtual machines, or the like. The host system 120 can request the number of PFs/VFs/ADIs needed. In some embodiments, each of the PFs/VFs/ADIs corresponds to a virtual memory controller that is associated with a different portion of the memory devices.

For example, the controller 115 can manage a number of physical functions (PFs). Physical functions are fully featured PCIe functions that can be discovered, managed, and manipulated like any other PCIe device, and thus can be used to configure and control a PCIe device. Each physical function is a PCI function that supports the virtualization capabilities, and thus physical functions can each allow enumeration of a number of virtual functions (VFs). The controller 115 can also manage virtual functions, virtual controllers, or the like to present themselves as physical functions and physical controllers to other devices, such as host system 120, connected to PCIe bus 210 by virtue of the physical function. The virtual functions can be lightweight PCIe functions that share one or more resources with one physical function and with virtual functions that are associated with that physical function. For example, the PCI configuration space of each virtual function can be accessed by a bus, device, and function (BDF) number of the physical function. Each virtual function can have a PCI memory space, which is used to map its register set. The virtual function device drivers operate on a register set to enable its functionality and the virtual function appears as an actual PCIe device, accessible by host system 120 over PCIe bus 210.

In some implementations, a technique of the single root input/output virtualization (SR-IOV) specification can be used to provide a direct assignment of virtual machine. SR-IOV is a specification that allows the isolation of PCI Express (PCIe) resources among various hardware functions for manageability and performance reasons, while also allowing that single physical PCIe device to be shared in a virtual environment. SR-IOV offers different virtual functions to different virtual components (e.g., a network adapter) on a physical server machine. SR-IOV also allows different virtual machines in a virtual environment to share a single PCIe hardware interface. SR-IOV defines two types of host-assignable interfaces or PCI functions: physical functions and virtual functions. Because the physical function allows enumerating a number of virtual functions and a hypervisor can then assign those virtual functions to one or more virtual machines, SR-IOV requires two sets of drivers including a physical function driver to enumerate the virtual functions and the kernel needs to support a complete SR-IOV capable stack, and then the virtual functions require another driver that only can run the virtual functions.

In some implementations, a technique of multiple physical functions (MPF) can be used to provide a direct assignment of virtual machine. MPF enables a memory system to use a non-volatile memory express (NVMe) virtualization schema to allow cloud computing services which do not natively support SR-IOV to be dynamically configured. This generates physical functions that are naturally visible to a host operating system or virtual machines running thereon, and does not rely on software translation performed by the hypervisor and PCIe. In one embodiment, a physical controller implemented by a field programmable gate array (FPGA), an application specific integrated circuit (ASIC), or other chip, includes multiple virtual NVMe controllers. Each virtual NVMe controller is assigned a segment, slice, portion, etc. of an underlying physical non-volatile storage device. There may be only a single underlying storage device that appears, by virtue of the multiple virtual NVMe controllers, as multiple individual storage devices to a host machine. In another embodiment, there may be multiple underlying storage devices that are presented as some greater number storage devices represented by the virtual NVMe controllers. All of the virtual NVME controllers have the same priority and same functionality. In addition, the physical controller can assign a number of input/output (I/O) queue pairs and one admin queue pair to each virtual NVMe controller.

In some implementations, a technique of scalable I/O virtualization (scalable IOV) can be used to provide a direct assignment of virtual machine. Scalable IOV is a PCIe-based virtualization technique that enables highly scalable and high performance sharing of I/O devices across isolated domains. The isolated domains may be virtual machines, process containers, machine containers, or application processes. Unlike the coarse-grained device partitioning approach of SR-IOV to create multiple VFs on a PF, scalable IOV enables software to segment address space into assignable interfaces. The assignable interface are a lightweight data structure that replaces VFs. Configuration space for assignable interfaces is emulated by software. The assignable interface provided by the scalable IOV can be referred to as assignable device interface (ADI). As such, performance of critical operations on the virtual device are mapped directly to the underlying device hardware, while non-critical operations are emulated through device-specific composition software in the host.

The controller 115 can create a set of namespaces by allocating physically-separate segments of storage to different namespaces. In other words, the namespaces are created so that operations performed on the namespaces would have minimum interference over each other. In some implementations, reclaim units (RUs) in Flexible Data Placement (FDP) are used. RUs are units of a physical, non-volatile storage that can be programmed, read, erased, reused, or repurposed without disturbing each other. Specifically, the controller 115 can select, for each namespace, a set of RUs to form a reclaim group (RG) and map the RG to the namespace. For example, a first set of RUs is located in Die 1, and a second set of RUs is located in Die 2; the controller 115 may select the first set of RUs to form a first RG and map the first RG to the Namespace 1, and the controller 115 may select the second set of RUs to form a second RG and map the second RG to the Namespace 2. In some embodiments, the number of namespaces can be preconfigured at manufacturing based on offline testing and media characterization of the memory device. In some embodiments, the number of the set of RUs that can be mapped to namespaces can be preconfigured at manufacturing based on offline testing and media characterization of the memory device.

In some implementations, the controller 115 may select a set of RUs based on a predetermined number of RUs (e.g., with a default value) or a number of RUs determined at the time of creating a virtual machine. In some implementations, the size of a namespace and the size of a RU are predefined, and the controller 115 may determine the number of the RUs to be a sum of the integer part (I) of the quotient of the size of the namespace divided by the size of the RU and an extra number (E), where the extra number allows the memory sub-system working efficiently, for example, used for over-provisioning, and the controller 115 may select the set of RUs based on the determined number of RU. For example, assuming that the size of a namespace is 128 GB and the size of a RU is 10 GB, the integer part (I) would be 12, and the extra number (E) can be 1, leading to the number of the RUs to be 13; in such a case, the memory sub-system controller can create a namespace by selecting a set of RUs having 13 RUs to form a RG and mapping the RG to the namespace.

After the controller 115 creates one or more namespaces, the controller 115, via a virtualization internal management component 113, can assign one reclaim unit handle (RUH) to each namespace. The RUH can be used to point to the RG that is mapped to the namespace, thus pointing to the set of RUs in the RG. The RUH is unique to the specific namespace, and the specific namespace can only have one RUH. Although RUH is used here, other forms of handles, tags, etc. can be used to replace RUH to reference to the namespace.

In some implementations, the controller 115 can store the assignment of the RUH to the namespace (e.g., identified by a namespace identifier) in a data structure. The data structure can also include a mapping of each RUs or a range of RUs to a particular namespace identifier. In some implementations, the data structure include one or more entries, including a namespace identifier, a RUH, a set of RUs (e.g., identified by physical addresses), a RU granularity (e.g., represented by a size), a size of RG. The RUH can be used to identify a namespace to which it is assigned. The namespace identifier can be used to identify a specific set of RUs to which the namespace is mapped. The set of RUs can be used to identify the segment of the memory device to perform the operation. The RU granularity can identify a size of one RU. In some embodiments, each namespace can have a RU granularity with a differing size than another namespace. In some embodiments, each namespace can have a RU granularity with the same size as another namespace or each namespace. The size of RG can represent the memory size provided by the namespace. In some embodiments, the size of RG can be up to the drive capacity of the memory device. In some embodiments, the size of RG is defined by a host system of the memory sub-system. In some embodiments, the size of RG is preconfigured at manufacturing based on offline testing and media characterization of the memory device.

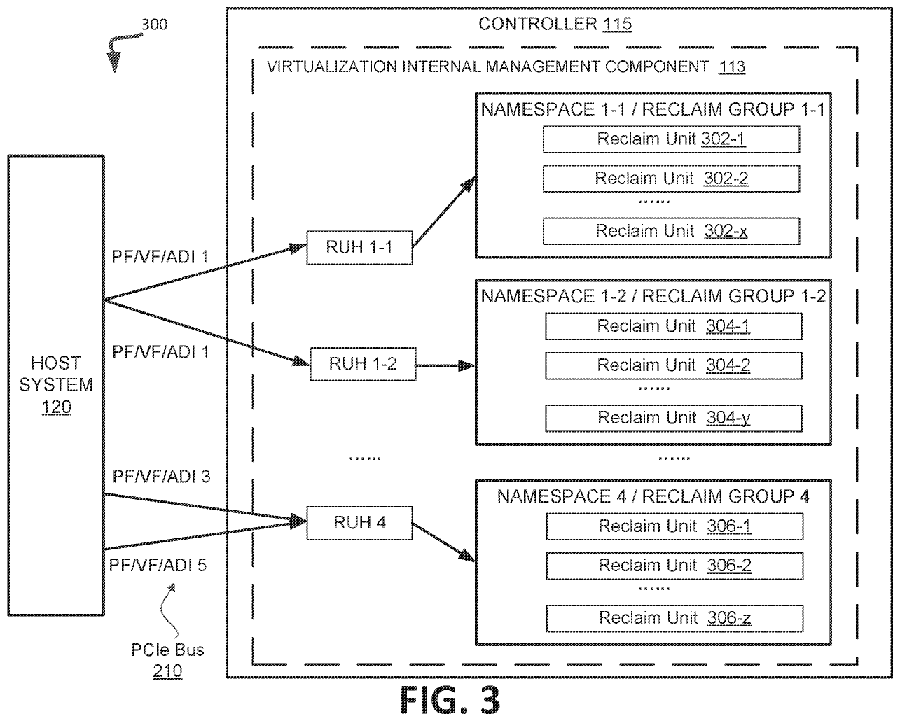

In some implementations, the host system 120 can assign one namespace to one PF/VF/ADI (e.g., all one-to-one assignment as shown in FIG. 2). In some implementations, the host system 120 can assign multiple namespaces to one PF/VF/ADI (e.g., multiple namespaces to one PF/VF/ADI 1 as shown in FIG. 3). In some implementations, the host system 120 can assign one namespace to multiple PFs/VFs/ADIs (e.g., one namespace 4 to multiple PFs/VFs/ADIs as shown in FIG. 3). As such, one or more namespaces can correspond to one PF/VF/ADI, or one namespace can correspond to one or more PFs/VFs/ADIs.

The controller 115 can receive a command (e.g., data access requests) from host system 120 over PCIe bus 210 via PFs, VFs, or ADIs, including requests to read, write, or erase data in a portion of a memory device (e.g., memory device 130). Because the host system 120 has assigned the namespace to the PF/VF/ADI, the command specifies a namespace in which the operation to read, write, or erase data would be performed. Responsive to receiving, by the controller 115, the command received from the host system 120 associated with one of PFs, VFs, or ADIs, the virtualization internal management component 113 can identify a RUH that is assigned to the namespace specified by the command. The RUH can be used to point to the RG that is mapped to the namespace, thus pointing to the set of RUs in the RG namespace. The virtualization internal management component 113 can identify an RG using the RUH, and the RG represents a segment of the memory device where the operation to write, read, or erase data will be performed.

The controller 115 can perform the operation specified by the command on the segment of the memory device. In some implementations, the controller 115 can identify a specific RU within the RG to perform the operation. For example, the controller 115 may identify the specific RU as the last-written place in the RG and continue writing on the specific RU for a write operation.

As shown in the example of FIG. 2, the controller 115 creates namespace 1 by allocating the reclaim group 1, where the reclaim group 1 includes reclaim units 202-1, 202-2, 202-x; the controller 115 creates namespace 2 by allocating the reclaim group 2, where the reclaim group 2 includes reclaim units 204-1, 204-2, . . . 204-y; the controller 115 creates namespace n by allocating the reclaim group n, where the reclaim group n includes reclaim units 206-1, 206-2, . . . 206-z. The controller 114 assigns RUH 1 to namespace 1, RUH 2 to namespace 2, and RUH n to namespace n. When the controller 115 presents a plurality of physical functions (PFs), virtual functions (VFs), or assignable device interfaces (ADIs) to the host system 120, the host system can assign namespace 1 to PF/VF/ADI 1, namespace 2 to PF/VF/ADI 2, and namespace n to PF/VF/ADI n. The controller 115 can receive, from host system 120 over PCIe bus 210 via PF/VF/ADI 1, a command to write data in a portion of a memory device, where the command can specify namespace 1, and the virtualization internal management component 113 can identify RUH 1 that is assigned to namespace 1, where RUH 1 points to reclaim group 1. The controller can decide a specific location in the reclaim group 1 to write data specified in the command. Similarly, the controller 115 can receive, from host system 120 over PCIe bus 210 via PF/VF/ADI 2, a command to write data in a portion of a memory device, where the command can specify namespace 2, and the virtualization internal management component 113 can identify RUH 2 that is assigned to namespace 2, where RUH 2 points to reclaim group 2.

FIG. 3 also illustrates a virtualization internal management component in a memory sub-system in accordance with some embodiments of the present disclosure. FIG. 3 illustrates a scenario of multiple namespaces to one PF/VF/ADI and a scenario of one namespace to multiple PFs/VFs/ADIs, while FIG. 2 illustrates the scenario of one namespace to one PF/VF/ADI. As shown in the example of FIG. 3, the controller 115 creates namespace 1-1 by allocating the reclaim group 1-1, where the reclaim group 1-1 includes reclaim units 302-1, 302-2, . . . 302-x; the controller 115 creates namespace 1-2 by allocating the reclaim group 1-2, where the reclaim group 1-2 includes reclaim units 304-1, 304-2, . . . 304-y; the controller 115 creates namespace 4 by allocating the reclaim group 4, where the reclaim group 4 includes reclaim units 306-1, 306-2, . . . 306-z. The controller 115 assigns RUH 1-1 to namespace 1-1, RUH 1-2 to namespace 1-2, and RUH 4 to namespace 4. When the controller 115 presents a plurality of physical functions (PFs), virtual functions (VFs), or assignable device interfaces (ADIs) to the host system 120, the host system can assign namespace 1-1 and namespace 1-2 to PF/VF/ADI 1, and assign namespace 4 to PF/VF/ADI 3 and PF/VF/ADI 5. The controller 115 can receive, from host system 120 over PCIe bus 210 via PF/VF/ADI 1, a command to write data in a portion of a memory device, where the command can specify namespace 1-1 or namespace 1-2, and the virtualization internal management component 113 can identify RUH 1-1 or 1-2 that is assigned to namespace 1-1 or 1-2, respectively, where RUH 1-1 or 102 points to reclaim group 1-1 or 1-2, respectively. The controller can decide a specific location in the reclaim group 1-1 or 1-2 to write data specified in the command. Similarly, the controller 115 can receive, from host system 120 over PCIe bus 210 via PF/VF/ADI 3 or PF/VF/ADI 5, a command to write data in a portion of a memory device, where the command can specify namespace 4, and the virtualization internal management component 113 can identify RUH 4 that is assigned to namespace 4, where RUH 4 points to reclaim group 4.

Managing the data placement of direct assigned virtual machine described above would also allow deleting of virtual machines performed easily. For example, the memory sub-system can identify the namespaces associated with the virtual machine that is to be deleted and can identify the reclaim group associated with the namespaces. The memory sub-system can free each of the identified reclaim group so that the reclaim group can be used by other virtual machines. Because the reclaim groups are isolated portions of memory device to each other, the erasing and programming of each reclaim group can be performed efficiently.

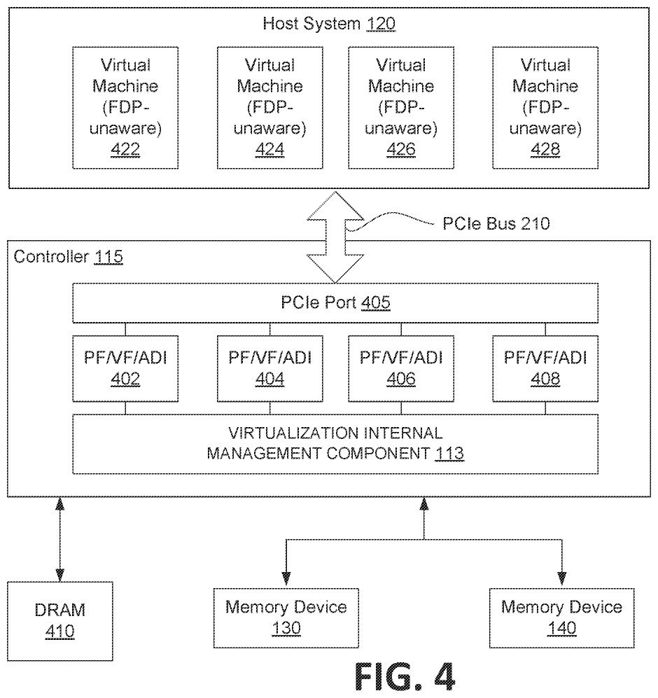

FIG. 4 illustrates a physical controller implementing a virtualization internal management component in accordance with some embodiments of the present disclosure. Host system 120 provide virtual machines 422-428, each is FDP-unaware. That is, each virtual machines 422-428 would not have any knowledge about the RUH. Controller 115 manages operations of storage media in the memory sub-system 110 including memory devices 130, 140 and optionally volatile memory, such as one or more dynamic random access memory (DRAM) devices 410. Controller 115 includes virtualization internal management component 113 and physical functions, virtual functions, or assignable device interfaces (PFs/VFs/ADIs) 402-408. PFs/VFs/ADIs 402-408 are coupled to PCIe port 405 which enables communications with host system 120 (via virtual machines 422-428) across PCIe bus 210. In one embodiment, controller 115 further includes an arbitrator component, which can arbitrate and select a port within PCIe port 405 and one from PFs/VFs/ADIs 402-408.

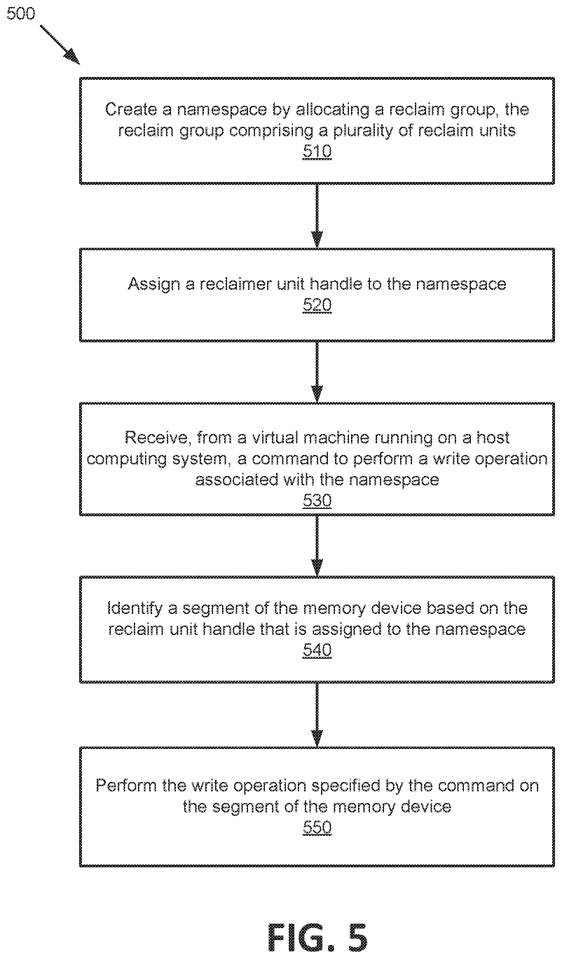

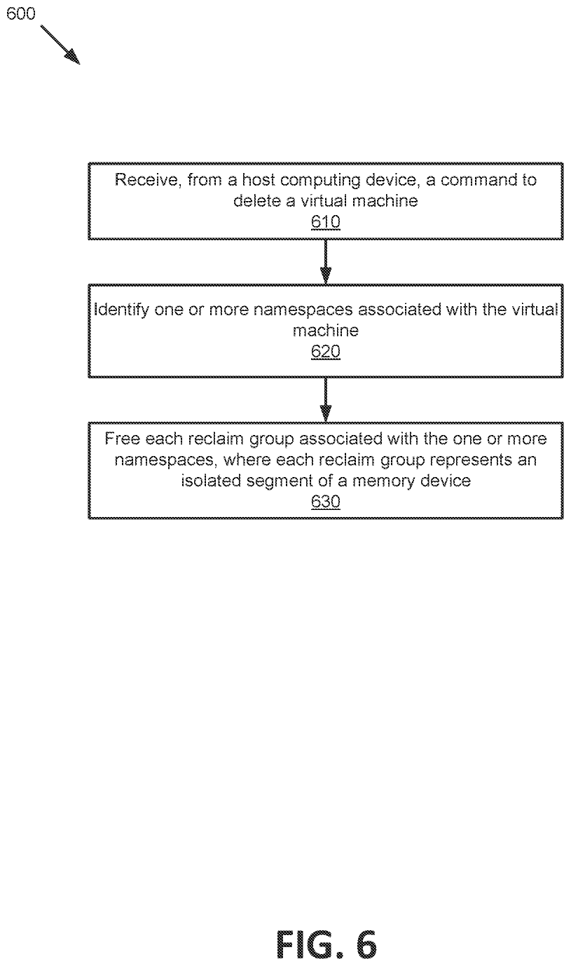

FIGS. 5-6 are flow diagrams of example methods 500-600 to manage the data placement of direct assigned virtual machine in a memory sub-system in accordance with some embodiments of the present disclosure. The methods 500-600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 500-600 are performed by the Virtualization internal management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 5, at operation 510, the processing device can create a namespace by allocating a reclaim group, the reclaim group comprising a plurality of reclaim units. In some implementations, the processing logic can calculate a number as a sum of an integer part of a quotient of a size of the namespace divided by a size of the reclaim unit and an extra number, and select, in view of the number, the plurality of reclaim units to form the reclaim group. The quantity of the selected reclaim units equals the number. At operation 520, the processing logic can assign a reclaim unit handle to the namespace. In some implementations, the reclaim unit handle is unique to the namespace, and the namespace is unique to the reclaim unit handle. The reclaim unit handle is a reference used to point to a specific reclaim group.

At operation 530, the processing logic can receive, from a virtual machine running on a host computing system, a command to perform a write operation associated with the namespace. The virtual machine is unaware of the reclaim unit handle. In some implementations, the processing logic can present a plurality of physical functions (PFs), virtual functions (VFs), or assignable device interfaces (ADIs) to the host computing system, wherein the namespace corresponds to one of the plurality of physical functions (PFs), virtual functions (VFs), or assignable device interfaces (ADIs). In some implementations, the namespace corresponds to two or more of the plurality of physical functions (PFs), virtual functions (VFs), or assignable device interfaces (ADIs) In some implementations, two or more namespaces corresponds to one of the plurality of physical functions (PFs), virtual functions (VFs), or assignable device interfaces (ADIs).

At operation 540, the processing logic can identify a segment of the memory device based on the reclaim unit handle that is assigned to the namespace. The reclaim unit handle is a reference used to point to a specific reclaim group, where the specific reclaim group corresponds to the segment of the memory device. At operation 550, the processing logic can perform the write operation specified by the command on the segment of the memory device.

Referring to FIG. 6, at operation 610, the processing device can receive, from a host computing device, a command to delete a virtual machine. In some implementations, the command indicates removal of all files associated with the virtual machine. At operation 620, the processing logic can identify one or more namespaces associated with the virtual machine. In some implementations, the processing logic can identify one or more namespaces associated with the virtual machine via a data structure, where the data structure maps the virtual machine to the corresponding namespaces. At operation 630, the processing logic can free each reclaim group associated with the one or more namespaces, where each reclaim group represents an isolated segment of a memory device. As described in operation 510, the namespace is created with a reclaim group allocated, the processing logic can identify the allocated reclaim group and free the reclaim group for other use. In some implementations, freeing the reclaim group may involve erasing the reclaim group. In some implementations, freeing the reclaim group may involve deleting one or more entries of a data structure, each entry associating the virtual machine with the namespace.

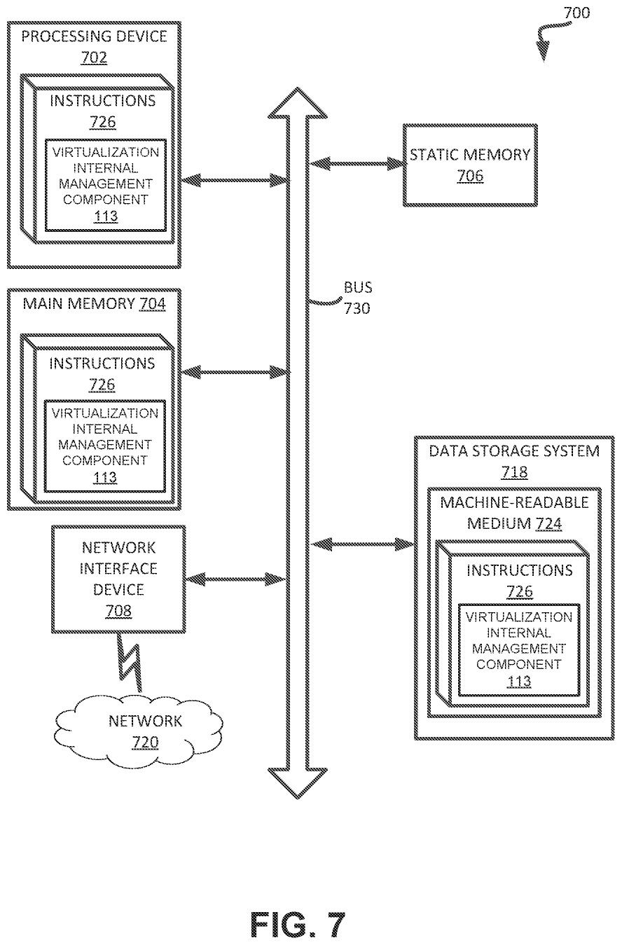

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the virtualization internal management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a caching component (e.g., the virtualization internal management component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory system comprising:
a memory device; and
a processing device coupled to the memory device, the processing device to perform operations comprising:
creating a namespace by allocating a reclaim group, the reclaim group comprising a plurality of reclaim units;
assigning a reclaim unit handle to the namespace;
receiving, from a virtual machine running on a host computing system, a command to perform an operation associated with the namespace;
identifying a segment of the memory device based on the reclaim unit handle; and
performing the operation on the segment of the memory device.

2. The memory system of claim 1, wherein the processing device is to perform operations further comprising:
selecting, in view of a number, the plurality of reclaim units to form the reclaim group, wherein the number comprises an integer part of a quotient of a size of the namespace divided by a size of the reclaim unit.

3. The memory system of claim 1, wherein the command specifies the namespace, and wherein identifying the segment of the memory device further comprises identifying the reclaim unit handle assigned to the namespace.

4. The memory system of claim 1, wherein the reclaim unit handle is unique to the namespace, and the namespace is unique to the reclaim unit handle.

5. The memory system of claim 1, wherein the processing device is to perform operations further comprising:
presenting a plurality of physical functions (PFs), virtual functions (VFs), or assignable device interfaces (ADIs) to the host computing system, wherein the namespace corresponds to a first one of the plurality of physical functions (PFs), virtual functions (VFs), or assignable device interfaces (ADIs).

6. The memory system of claim 5, wherein the namespace corresponds to the first one and a second one of the plurality of physical functions (PFs), virtual functions (VFs), or assignable device interfaces (ADIs).

7. The memory system of claim 5, wherein another namespace corresponds to the first one of the plurality of physical functions (PFs), virtual functions (VFs), or assignable device interfaces (ADIs).

8. The memory system of claim 1, wherein the virtual machine is unaware of the reclaim unit handle.

9. The memory system of claim 1, wherein the operation comprises a write operation.

10. The memory system of claim 1, wherein the processing device is to perform operations further comprising:
receiving, from a host computing device, a command to delete the virtual machine;
identifying one or more namespaces associated with the virtual machine; and
freeing each reclaim group associated with the one or more namespaces, wherein each reclaim group represents an isolated segment of the memory device.

11. A method comprising:
creating, by a processing device, a namespace by allocating a reclaim group, the reclaim group comprising a plurality of reclaim units;
assigning a reclaim unit handle to the namespace;
receiving, from a virtual machine running on a host computing system, a command to perform a write operation associated with the namespace;
identifying a segment of the memory device based on the reclaim unit handle that is assigned to the namespace; and
performing the write operation on the segment of the memory device.

12. The method of claim 11, further comprising:
selecting, in view of a number, the plurality of reclaim units to form the reclaim group.

13. The method of claim 12, further comprising:
calculating the number as a sum of an integer part of a quotient of a size of the namespace divided by a size of the reclaim unit and an extra number.

14. The method of claim 11, wherein the reclaim unit handle is unique to the namespace, and the namespace is unique to the reclaim unit handle.

15. The method of claim 11, further comprising:
presenting a plurality of physical functions (PFs), virtual functions (VFs), or assignable device interfaces (ADIs) to the host computing system, wherein the namespace corresponds to one of the plurality of physical functions (PFs), virtual functions (VFs), or assignable device interfaces (ADIs).

16. The method of claim 11, wherein the virtual machine is unaware of the reclaim unit handle.

17. A non-transitory computer readable storage medium comprising instructions, which when executed by a processing device, cause the processing device to perform operations comprising:
creating a namespace by allocating a reclaim group, the reclaim group comprising a plurality of reclaim units;
assigning a reclaim unit handle to the namespace;
receiving, from a virtual machine running on a host computing system, a command to perform an operation associated with the namespace;
identifying a segment of the memory device based on the reclaim unit handle that is assigned to the namespace; and
performing the operation on the segment of the memory device.

18. The non-transitory computer readable storage medium of claim 17, wherein the instructions cause the processing device to perform operations further comprising:
calculating a number as a sum of an integer part of a quotient of a size of the namespace divided by a size of the reclaim unit and an extra number; and
selecting, in view of the number, the plurality of reclaim units to form the reclaim group.

19. The non-transitory computer readable storage medium of claim 17, wherein the reclaim unit handle is unique to the namespace, and the namespace is unique to the reclaim unit handle.

20. The non-transitory computer readable storage medium of claim 17, wherein the virtual machine is unaware of the reclaim unit handle.
